(19) United States
(12) Patent Application Publication
(10) Pub. No.: US 2026/0155695 A1
(43) Pub. Date: Jun. 4, 2026

(54) STATOR END TURN PROTECTION FROM PARTIAL DISCHARGE EVENTS IN ELECTRICAL SUBMERSIBLE PUMP (ESP) MOTORS

(71) Applicant: Halliburton Energy Services, Inc., Houston, TX (US)

(72) Inventor: Hassan Mansir, Frimley (GB)

(21) Appl. No.: 18/967,187

(22) Filed: Dec. 3, 2024

(51) Int. Cl. H02K 3/40; E21B 43/12; F04D 13/06; F24T 10/20; H02K 3/34; H02K 5/132; H02K 15/106

(52) U.S. Cl. CPC H02K 3/40; E21B 43/128; F04D 13/06; F24T 10/20; H02K 3/345; H02K 5/132; H02K 15/106

(57) ABSTRACT

Some implementations include an apparatus comprising a member configured to couple to an end of a stator core of an electrical submersible pump (ESP) motor, the ESP motor to be positioned in a wellbore, wherein the member has a bore through which a motor rotor is to be located, wherein one or more slots are formed in the member around a perimeter of the bore, wherein the member includes a doped material, and wherein the member including the doped material exhibits one or more semiconductive characteristics. The apparatus further includes a laminate material configured to be positioned within at least one of the one or more slots, wherein the laminate material includes at least one of a conductive layer or an insulative layer.

### TECHNICAL FIELD

The disclosure generally relates to wellbores formed in subsurface formations, and in particular, to electric motors of electrical submersible pumps used to extract hydrocarbons or other fluids from subsurface formations.

### BACKGROUND

In electrical submersible pump (ESP) motors, such as those used in oil production and geothermal applications, a prevailing trend is to increase the shaft power to cater to increasing production rates. As the cable that supplies power from the surface to the motor occupies the space between the motor and the well casing inside diameter, there may be a desire to reduce the size of the cable to maximize the diameter of the motor and limit its length. To deal with this challenge, designers may respond by elevating the motor's voltage rating to align with the cable's safe current handling capacity. Yet, surpassing a five kilovolt (kV) rating may present formidable challenges given the space limitations within downhole motor stator slots and end turns. Meeting electrical insulation standards between conductors to ground and conductors to conductors, as well as mitigating partial discharge events may necessitate incorporating additional layers of material into the electrical insulation system. However, these materials may be restricted by their temperature capability. Furthermore, accommodating these materials within the limited spaces may pose further hurdles.

A large portion of ESP motor failures may occur in the end turns or end turn region due to a thermal effect during no flow events, high motor currents, or due to long-term exposure to partial discharge (PD) events. These PD events may weaken the wire's electrical insulation in the end turns over time. PD events may also limit the ability of the wire's electrical insulation to override intermittent thermal events. Increasing working voltage may also increase the likelihood of PD resultant failures. To prevent electrical insulation failures (especially those between the stator core and the conductors, as well as between the conductors within the core), the coils may typically be covered with insulating materials, and additional insulating material may be introduced at the end turn region. The end turn region may be the location where the conductors enter and exit the stator core.

During operation, these insulating layers may be subjected to large electric fields due to large voltage differences between, for example, the conductors and grounds, conductors and conductors, etc. The electrical insulation may sometimes contain imperfections which may arise during manufacturing, operation, etc. These imperfections may include air bubbles, inclusions, de-laminations, and/or airgaps. For example, airgaps may appear between different layers and around the edges of insulating tape which may be wrapped around the copper conductors that form each coil. The airgaps may also arise between the tape and the conductor. Accordingly, these imperfections within the electrical insulation may be subjected to the large electric fields due to the large voltage differentials. PD events may occur at these imperfections if the electric field, generated as a result of voltage differentials, exceeds the breakdown electric field of air or of the insulating material. These PD events may result in arcing or sparking. Repeated sparks may degrade the electrical insulation. Erosion of the electrical insulation over time may lead to PD resultant failures of the electrical insulation.

Ionized gases and electrical discharges due to PD events may lead to damage in the insulating material, leading to a degradation in the performance and eventual failure of the electrical motor. In particular, PD events and PD resultant failures of the insulating material may occur at the areas where the conductors enter the stator core. It is believed that many motor electrical insulation failures may be due to PD events, even in standard voltage motors. PD events and PD resultant failures may also affect the operating life of motors in critical applications, such as those used in geothermal wells. As development of high-power ESP motors (approximately 1500+ horsepower) progresses, the PD issue may become a critical condition that needs to be addressed.

Conventional solutions to prevent PD presence in insulating materials may typically revolve around selecting materials highly resistant to PD damage, such as mica-based electrical insulation, or the use of conductive or semi-conductive dielectric coatings, tapes, polymer nanocomposites, or functionally graded materials. However, such solutions may prove impractical for ESP motors due to the brittleness of mica-based electrical insulation systems and the inherent risk to the integrity of the electrical insulation system by the sew-through winding method used in the manufacturing of ESP motor stators. Hence, the pursuit of solutions that may withstand high electric fields without compromising the mechanical and thermal integrity of the motor remains paramount.

### BRIEF DESCRIPTION OF THE DRAWINGS

Implementations of the disclosure may be better understood by referencing the accompanying drawings.

FIG. 1 is an illustration depicting an electrical submersible pump (ESP) installation in a well, according to some implementations.

FIG. 2 is an illustration depicting a motor core assembly of the ESP with its main parts.

FIG. 3A is an illustration depicting an end turn support structure.

FIG. 3B is an illustration depicting an exploded view of the end turn support structure of FIG. 3A.

FIG. 4 is an illustration depicting a magnified view of an end turn assembly.

FIG. 5 is an illustration depicting a magnified view of an end turn assembly and one illustrative conductor bundle.

FIG. 6 is an illustration depicting a modified end turn support structure, according to some implementations.

FIG. 7 is an illustration depicting a modified end turn support partial assembly including stator laminations and a support plate, according to some implementations.

FIG. 8 is an illustration depicting an end turn including a slot liner and one conductor bundle, according to some implementations.

FIG. 9 is a cross-sectional diagram depicting a modified end turn support structure including stator laminations and the support plate, according to some implementations.

FIG. 10 is an illustration depicting the modified end turn support structure and a protective film, according to some implementations.

FIG. 11 is a cross-sectional diagram depicting the modified end turn support structure and the protective film, according to some implementations.

FIG. 12 is an illustration depicting side views of the modified end turn support structure including the protective film, according to some implementations.

FIG. 13 is a flowchart depicting an example method of operations, according to some implementations.

FIG. 14 is an illustration depicting an example ESP configured for use in a geothermal well, according to some implementations.

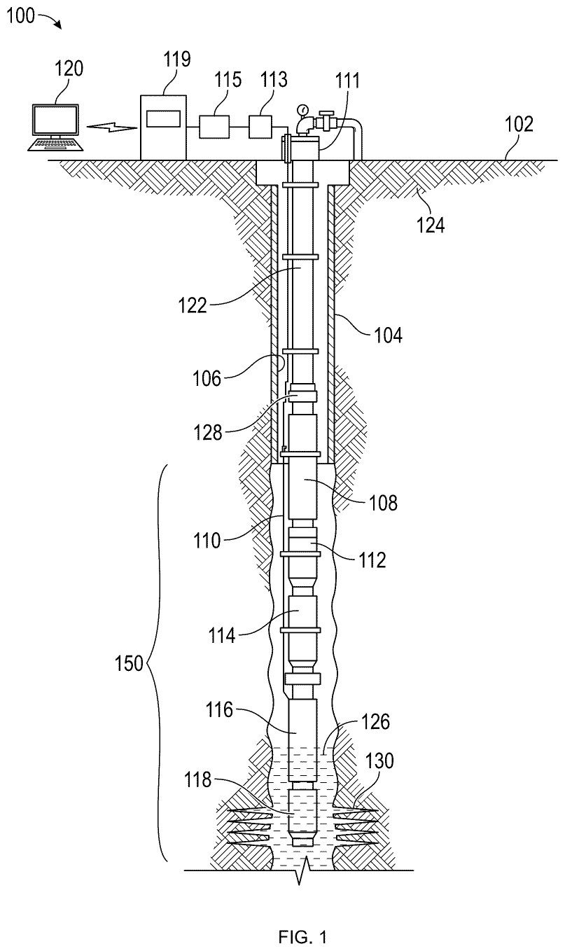

FIGS. 1-14 and the operations described herein are examples meant to aid in understanding example implementations and should not be used to limit the potential implementations or limit the scope of the claims. Some implementations may perform additional operations, fewer operations, operations in parallel or in a different order, and some operations differently.

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

### DESCRIPTION

Composite materials and nanotechnologies may be integrated with existing motor electrical insulation features of high-voltage ESPs to suppress and/or protect against PD events. Examples of high-voltage ESPs may include ESPs configured to operate using voltages between four kilovolts and ten kilovolts. Example high-voltage ESPs may include ESPs configured to operate at voltages greater than four kilovolts, greater than five kilovolts, greater than six kilovolts, etc. However, other voltage ratings may be possible). Alternatively, ESPs configured to operate with electrical power having a voltage less than four kilovolts or greater than ten kilovolts may also be possible. In contrast to traditional ESP motor assemblies, a modified end turn support structure may be included past a final set of laminations where the windings/conductors exit the stator core. The modified end turn support structure may introduce features to enable a controlled diffusion of the electric field where the windings exit the motor. Such features may include modified materials used in the formation of the end turn support structure such that it exhibits one or more semiconductive properties, a laminated material included in each of the slots of the end turn support structure, and closed slots with deepened side walls and/or pockets.

Accordingly, the modified end turn support structure may be comprised of an insulating material supplemented with a conductive or doped semiconductive material in its construction. Therefore, at least a portion of the current from the conductor bundles may flow into the modified end turn support and diffuse the concentration of the electric field in the end turn region. The geometry and material of the end turn support structure may be modified to increase its resilience to high-voltage partial discharge events. Some implementations may use a thermoplastic insulator such as Polyether ether ketone (PEEK) modified with the inclusion of a doped microvaristor. In some implementations, the microvaristors may refer to materials with non-linear electrical properties such as non-linear conduction and dielectric properties. The microvaristors may be used as a filler within a composite material to alter the electrical properties of the composite material.

Some implementations of the microvaristors may be doped by a dopant to further enhanced the electrical properties of the microvaristors, and these changes may also be observed in a resulting doped-microvaristor composite material. Some implementations of a doped microvaristor may be formed from doped Zinc Oxide (ZnO). Some implementations of the doped microvaristors may also be referred to as ZnO microvaristors. The ZnO microvaristors may exhibit non-linear conduction properties and limit the magnitude of the electric field (E) in and at the vicinity of the resulting PEEK composite. The addition of an amount of doped ZnO may introduce a non-linear and variable resistance effect that enhances the distribution of the electric field in the end turn area. For example, the end turn support structure with inclusion of doped microvaristors may reduce peak values in the electric field at any point-location within the PEEK electrical insulation. Controlling the electric field nonuniformity through the end turn region may reduce the electrical stress of insulation materials and reducing both the severity and rate of occurrence of PD events. In some implementations, the doped microvaristor may reduce or redirect the electric field through the PEEK electrical insulation, lowering the electrical flux within and around the PEEK electrical insulation. Thus, PD inception voltage levels may be limited in the inherent imperfections in the wire electrical insulation. Reducing the electric field magnitude and optimizing its distribution may both reduce the incidence rate of PD events and limit the negative effects of PD events that do occur. The reduction in both incidence and severity of PD events may enhance the reliability and durability of motor stators.

Additionally, the modified end turn support may also include a laminated material within each of its slots to enhance PD event protection. The laminated material may include a multi-layer film having interleaved conductive and insulative layers. In some implementations, the conductive layers and insulative layers may alternate such that within the laminated material, one conductive layer does not directly contact another conductive layer and one insulative layer does not contact another insulative layer. The laminated material may extend beyond both ends of each of the slots. The laminated material may diffuse the electric charge as the windings exit the stator core, leading to fewer PD events compared to traditional electrical insulation systems for a given voltage level. The electrical insulation may also reduce the severity of PD events that do occur.

In some implementations, the laminated material may be comprised of a protective composite polyimide film having at least one conductive layer. This protective film may enhance the distribution of the electrical field at the entry of the slots of the end turn structure. The film may include at least two layers-one insulating layer and one conductive layer—and may be capable of operation at temperatures greater than or equal to 325° C. in dielectric oil, although operation at other temperatures may be possible. Some implementations of the protective composite polyimide film may comprise a DuPont Kapton® polyimide film. However, other materials for the protective film may also be used. In some implementations, the total thickness of the film may be 0.05 mm with a dielectric capability of greater than 2.5 kilovolts of alternating current (kVAC). Multiple layers of the composite film may be used if higher dielectric withstand voltages are required. These modified electrical insulation systems may be capable of enduring extreme conditions while maintaining optimal performance levels. Additionally, the use of manufacturing techniques, such as additive manufacturing, may be used to create electrical insulation designs tailored to specific and varied ESP applications. The modifications to the ESP electrical insulation may enhance the overall reliability and longevity of electrical submersible pumps motors in demanding environments.

The addition of partially conductive components or films as part of the motor insulation system may prevent PD events from occurring on the surface of the stator coils and in any air gaps or imperfections which may be present between the coil surface and the stator core, or in the end winding near the end of the stator core. PD events may occur between the coil (windings) and the stator core for a similar reason that may cause PD events to occur in air pockets within the electrical insulation. As the multiple conductors of a coil are inserted into the slots of the stator core, air gaps may exist between the conductor surfaces and the core. In imperfections within the electrical insulation of the windings, a large percentage of the supply voltage may appear across the air gaps. If the electric field in an air gap exceeds the breakdown strength (also referred to as the dielectric strength) of air, which may be three kilovolts per millimeter (kV/mm) at room temperature and atmospheric pressure, a PD event may occur.

Protection against PD events may extend the run life of existing ESP motors and reduce the severity of PD events in ESP motors rated for higher voltage and higher horsepower. Current conventional ESP motors may be rated to produce shaft powers of 1,200 horsepower typically, whereas future ESPs may need to produce 3,000 horsepower or more. Voltage through the conductors and to the motor may be increased to achieve these higher horsepower ratings. For example, conventional ESPs and their associated power cables may utilize voltages of approximately 5 kilovolts (5 kV) but this figure may increase to 7-9 kV for future ESP systems. The increased voltages may contribute to a partial discharge-rich environment especially at the end turn location(s). To prevent PD events on the coil surfaces, the end turn support and the slot entry electrical insulation may be modified with partially-conductive materials. Therefore, material and technological modifications in the end turn region may be used to improve the immunity of the motor and various electrical insulation systems to partial discharge events. These modifications may be advantageous for both current and future ESP systems.

### Example Well System

FIG. 1 is an illustration depicting an electrical submersible pump (ESP) installation in a well, according to some implementations. A well system 100 may include a casing 106, an electrical submersible pump 108 (“pump 108”), a power cable 110, a wellhead 111, a gas separator 112, a junction box 113, a seal section 114, a transformer 115, an electric motor 116 (“motor 116”), a sensor 118 (also referred to as a gauge), a variable speed drive (VSD) 119, a controller 120, a production tubing 122 (“tubing 122”), a subsurface 124 including one or more subsurface formations, a fluid 126, a pump discharge 128, perforations 130, and an ESP system 150. At least a portion of the well system 100 may be configured to operate within the wellbore 104 or at the surface 102. While the well system 100 is depicted within a land-based subterranean environment, other implementations of the well system 100 may employ any well site environment including a subsea environment. In some implementations, any one or more components or elements described may be used with subterranean operations and/or equipment located on offshore platforms, drill ships, semi-submersibles, drilling barges, land-based rigs, etc. For example, the pump 108 may be used in a deep water offshore well in water depths greater than one thousand meters.

The well system 100 may represent an applicable environment in which a substance may be pumped through the wellbore 104 toward the surface 102. For example, various types of hydrocarbons, water, or other fluids may be pumped or otherwise transported from the wellbore 104 to the surface 102. In some implementations, the well system 100 may be positioned (at least partially) in the wellbore 104 below the surface 102 in or proximate to one or more subsurface formations of the subsurface 124. The wellbore 104 may comprise a vertical, deviated, horizontal, or any other type of wellbore. The wellbore 104 may be defined in part by a casing 106 that may extend from the surface 102 to a selected downhole location. Portions of the wellbore 104 that do not comprise the casing may be referred to as open hole. Some implementations of the well system 100 may represent a geothermal environment in which a fluid such as water, carbon dioxide (CO2), one or more hydrocarbons, one or more refrigerants, or other fluids used for heat transfer may be pumped through the wellbore 104 toward the surface 102. In some implementations, the wellbore 104 may include a closed-loop geothermal wellbore, although other geothermal wellbore configurations may be possible.

In some implementations, the well system 100 may include the ESP system 150 disposed within the wellbore 104. The ESP system 150 may include a multi-stage centrifugal pump system configured to transport the fluid 126 to the surface 102. Some implementations of the ESP system 150 may be configured to transport the fluid 126 further into the wellbore 104. In other implementations, the ESP system 150 may instead be comprised of a different electric motor system configured for use in the wellbore 104 and including a rotor and stator. The ESP system 150 may include a computer system such as the controller 120 which may be communicatively coupled with one or more components disposed downhole in the wellbore 104. Specifically, the ESP system 150 may include the sensor 118, the motor 116, the seal section 114, the gas separator 112, the pump 108, the tubing 122, and the power cable 110. In some implementations, the power cable 110 may include communications and capillary lines; therefore, the power cable 110 may be configured to convey both power from a power generation unit and commands from the controller 120 and VSD 119 to the motor 116.

The components of the ESP system 150, in combination, may function to perform various tasks related to pumping a substance through the wellbore 104 toward the surface 102. For example, the ESP system 150 may be configured to pump the fluid 126 to the surface 102. The fluid 126 may exit the ESP system 150 at the pump discharge 128, and the fluid 126 may travel to the surface 102 via the tubing 122. The controller 120 may function to control and interact with the various downhole components for performing various tasks related to pumping a substance through the wellbore 104 towards the surface 102. In some implementations, the controller 120 may be configured to determine pressures, flow rates, and other properties of the ESP system 150.

The sensor 118 may function to generate downhole data of one or more monitored parameters. Specifically, the downhole data may include any suitable data that may be measurable downhole. For example, the sensor 118 may be configured to obtain measurements of temperature, pressure, vibrations, concentration, density, etc. In some implementations, the sensor 118 may include a pressure gauge that is configured to identify a wellbore pressure at an intake of the pump 108 or at a discharge of the pump 108. However, other sensing devices and sensor types may be used. Additionally, the sensor 118 may function to measure parameters for preventing or reducing formation damage caused by overproduction through the wellbore 104. The sensor 118 may communicate with the controller 120 in generating downhole data. Specifically, the sensor 118 may provide the downhole data as telemetry data to the controller 120, where the downhole data may be used in controlling a production operation of the ESP system 150. In some implementations, a flow meter or a similar sensor may be disposed at the surface 102, positioned on an interior or an exterior surface of the tubing 122, positioned within the wellhead 111, etc. to measure a parameter of the fluid 126 as it is produced to the surface 102. Without limitations, the flow meter may be replaced with any suitable sensor utilized to measure a parameter of the fluid 126.

Surface electrical components such as the junction box 113, transformer 115, and VSD 119 may be used, at least in part, to control one or more aspects of the ESP system 150. For example, the junction box 113 may serve as a junction to connect and disconnect electrical cables from surface 102 (including the transformer 115, VSD 119, etc.) to those deployed into the wellbore 104, such as the power cable 110. The junction box 113 may ensure safe power delivery to the motor 116 and may provide a means to isolate the motor 116 from the surface electrical components (i.e., for repair, maintenance, troubleshooting) without disrupting other surface electrical components. The transformer 115 may be a step-up transformer configured to convert low-voltage power from a power generation unit or power supply to a voltage suitable for use by the ESP system 150. For example, the transformer 115 may convert low-voltage power of 440 to 690 Volts. to a voltage suitable for use by the ESP system 150. However, a power supply configured to output a voltage greater than 690 volts may also be used. A voltage suitable for use by the ESP system 150 may, for example, include voltages within an operating range between four kilovolts and ten kilovolts. However, the ESP system 150 may also be configured to operate with voltages less than four kilovolts or greater than ten kilovolts. The transformer 115 may be coupled to at least the junction box 113 and the VSD 119. The VSD 119 may be a speed control system configured to alter the speed of the motor 116. The VSD 119 may be coupled with at least the transformer 115 and communicatively coupled to the controller 120. In some implementations, the VSD may be configured to vary the alternating current frequency of the motor 116 which may change the speed of the motor 116. Changes to the function of the motor 116 may affect the operation of the pump 108.

The pump 108 may be an applicable pump that is capable of pumping production substances, such as the fluid 126, toward the surface 102 of the wellbore 104. For example, the pump 108 may comprise a multi-stage centrifugal pump. The pump 108 may transfer pressure to downhole fluid, such as the fluid 126, by adding kinetic energy to the fluid via centrifugal force. The pump 108 may additionally convert the kinetic energy to potential energy in the form of pressure. The pump 108 may lift the fluid 126 to the surface 102. In some implementations, the pump 108 may be coupled to a pump flow control system above, below, or proximate to the pump 108 which may comprise a housing. The pump flow control system may be configured to receive commands from the controller 120 and adjust one or more operating parameters of the pump 108. In some implementations, the controller 120 may be configured to output commands to the VSD 119. The VSD 119 may alter a property of the motor 116 which may induce an effect at the pump 108.

The seal section 114 may be disposed between the motor 116 and the intake of the pump 108. The seal section 114 may function to isolate components higher in the wellbore 104 from the downhole fluids such as the fluid 126 and may be configured to equalize a pressure in the wellbore 104 with a pressure in the motor 116. In some implementations, the seal section 114 may function to receive and dissipate thrust generated from a column of the fluid 126 lifting through the pump 108.

The gas separator 112 may be positioned between the pump 108 and the seal section 114. The gas separator 112 may serve, at least in part, as an intake for the pump 108. In particular, the gas separator 112 may function to separate gas from the fluid 126 in the wellbore 104 and allow for the entry of the separated fluid into the pump 108. The gas separator 112 may be an optional component in the ESP system 150.

The fluid 126 may include a downhole fluid to be produced through the ESP system 150. The fluid 126 may be a multi-phase wellbore fluid comprising one or more hydrocarbons. For example, the fluid 126 may be a two-phase fluid that comprises a gas phase and a liquid phase from the wellbore 104 or a reservoir, subsurface formation, etc. of the subsurface 124. The fluid 126 may enter the wellbore 104 through one or more perforations 130 in the subsurface formation and flow uphole to one or more intake ports of the ESP system 150. These intake ports may be positioned at a distal end of the pump 108. The pump 108 may pump the separated liquid output from the gas separator 112 to the surface 102. The separated liquid that is output from the gas separator 112 and input into the pump 108 may include dissolved gas in solution.

The tubing 122 may include production tubing which may be coupled to the pump 108 using one or more connectors. In some implementations, the tubing 122 may be coupled directly to the pump 108. One or more sections of the tubing 122 may be coupled together to extend the ESP system 150 into the wellbore 104 to a desired depth or formation within the subsurface 124.

The power cable 110 may extend from the surface 102 down to the ESP system 150. The power cable 110 may comprise a cable configured to convey power from power generation or power storage equipment at the surface 102 to the motor 116. In some implementations, the power cable 110 may be a round cable, a flat cable, any combination thereof, or of any other suitable geometry. In some implementations, the power cable 110 may be configured to convey data to and from the equipment at the surface 102 and the ESP system 150 in addition to supplying power to the motor 116. In some implementations, the data may comprise one or more control or operation instructions transmitted via the controller 120, to which the power cable 110 may be communicatively coupled with. Accordingly, the power cable 110 may be communicatively coupled with at least the junction box 113, transformer 115, VSD 119, and controller 120.

The power cable 110 may be conveyed from the surface 102 to a packer (not shown) or similar pressure and/or fluidic barrier disposed along, between, or proximate to one or more sections of the tubing 122. The power cable 110 may be passed through a feedthrough or a penetrator of the packer to allow the power cable 110 to pass without jeopardizing a seal created by the packer or similar device. Below the packer, the power cable 110 may comprise a motor lead extension (MLE) coupled to a pothead of the motor 116, where the MLE is configured to provide electrical power to the motor 116. In some implementations, the power cable 110 may comprise three individual wires, each comprising individual conductors and electrical insulation sheaths. For example, the power cable 110 comprising the three-wire system may be configured to convey three-phase alternating current (AC) power at a multi-kilowatt scale to power the motor 116. Some implementations of the power cable 110 may be configured to supply between 75 kilowatts (kW) to 2.5 Megawatts (MW) to the motor 116. Other configurations may also be possible.

The motor 116 may function to drive the pump 108. Specifically, the motor 116 may receive power from a power supply, power generation unit, etc. coupled with the controller 120 at the surface 102. Power may be conveyed to the motor 116 via the power cable 110 and may drive the pump 108 in lifting the fluid 126 and other produced substances and/or downhole fluids towards the surface 102. The motor 116 may be an applicable and appropriately sized motor that may drive the pump 108. In some implementations, the motor 116 may include an electrical submersible motor configured/operated to turn the pump 108 and may, for example, be a two or more-pole, three-phase squirrel cage induction motor or a permanent magnet motor (PMM). However, other motor configurations may be possible. The motor 116 may be coupled to the sensor 118.

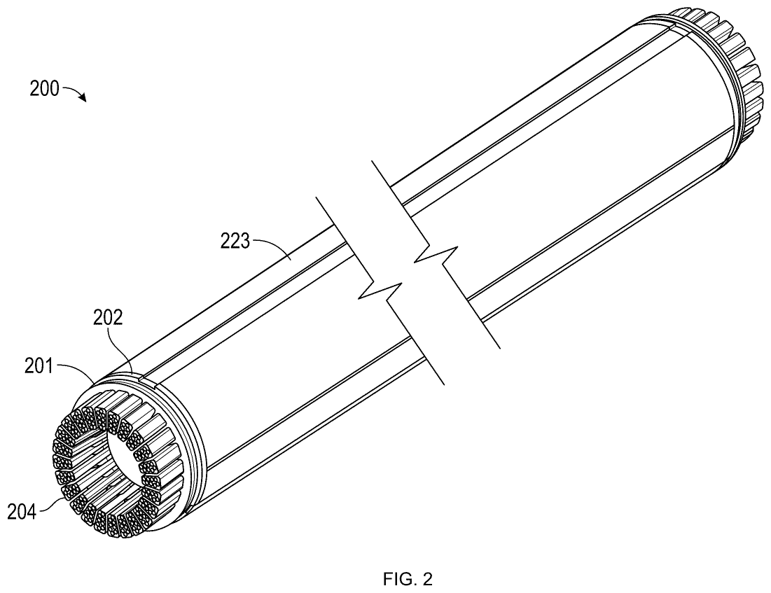

The motor 116 of the ESP system 150 may include a stator core (stator), a rotor core (rotor), and a plurality of windings. Failures of the ESP system 150 may occur due to partial discharge (PD) events in the motor 116. Specifically, the PD events may occur at an end turn structure of the motor 116 in which damage to insulating material(s) may result in the failure of the motor 116 and ESP system 150. The motor 116 and end turn structure of traditional/conventional ESPs are described with additional detail in FIG. 2.

### Example Traditional ESP Components

FIG. 2 is an illustration 200 depicting a motor core assembly of the ESP with its main parts. The illustration 200 shows a motor core assembly 223 which may comprise the stator of FIG. 1's motor 116. The motor core assembly 223 may be coupled with a stator core support plate 202, and the stator core support plate 202 may be coupled with an end turn support structure 201. A plurality of windings 204 may extend through slots within the end turn support structure 201. Each winding of the windings 204 may include a conductor bundle comprised of a plurality of conductors (e.g., such as copper wires). The windings 204 may include electrical insulation around each conductor bundle and electrical insulation around each individual conductor.

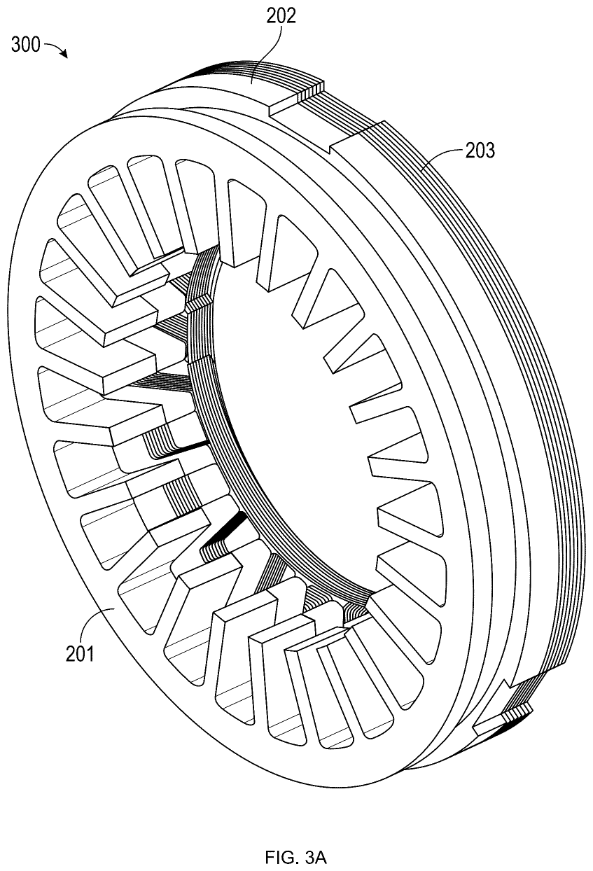

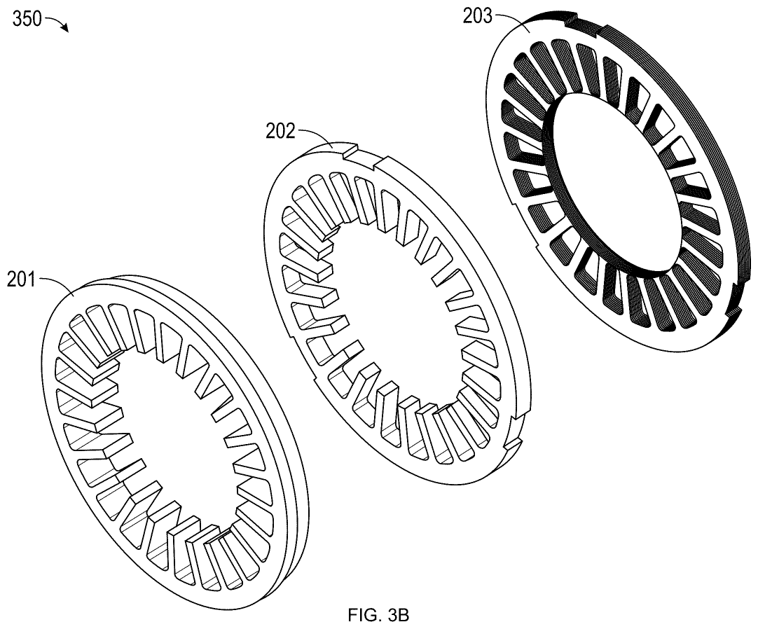

FIG. 3A is an illustration 300 depicting an end turn support structure. The illustration 300 shows the end turn support structure 201 coupled with a partial section of the stator core of the motor 116. In particular, the partial section of the stator core includes a partial stack of laminations 203 (referred to as the laminations 203) which may be coupled to the stator core support plate 202. The end turn support structure 201 may portray a conventional end turn support structure configuration including a plurality of open slots through which the windings 204 may pass through. The end turn support structure 201 may be an electric insulator made from materials such as ceramics or polymers.

FIG. 3B is an illustration 350 depicting an exploded view of the end turn support structure of FIG. 3A. The illustration 350 includes the laminations 203, the stator core support plate 202, and the end turn support structure 201. As shown, traditional end turn supports such as the end turn support structure 201 may include a plurality of open slots without slot extensions. As such, the depth of each slot and any electrical insulation provided by it may only span the thickness of the end turn support structure 201.

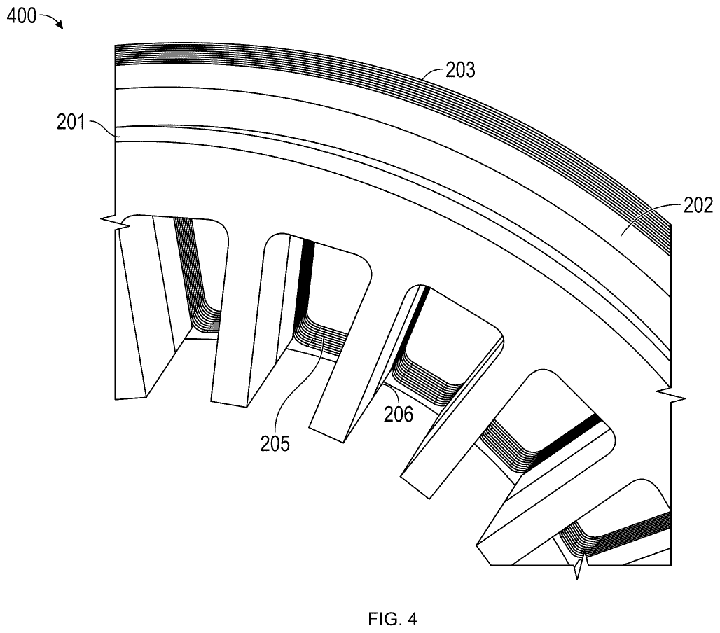

FIG. 4 is an illustration 400 depicting a magnified view of an end turn assembly. The illustration 400 includes the laminations 203, stator core support plate 202, end turn support structure 201, a stator core edge 205, and a stator core support plate edge 206. The stator core edge 205 may encompass a slot in which a winding/conductor bundle may pass through. The stator core edge 205 may be a structural detail formed by a stack of the laminations 203 of the stator core. The stator core support plate edge 206 may be a structural detail of the stator core support plate 202. As both the laminations 203 and the stator core support plate 202 are electric conductors connected to the motor casing, which is at ground potential (not shown), at least a portion of the laminations 203, and particularly, at the stator core edge 205, may be subject to high-strength electrical fields whenever the motor is energized from the surface. The electrical fields may induce PD events in operation of the ESP.

Traditional end turn supports, such as the end turn support structure 201, may be comprised of insulating materials such as thermoplastic insulators (e.g., PEEK, polyethylene (PE), Polyvinyl Chloride (PVC), etc.). A thermoplastic insulator may be defined as a thermoplastic material having electrically insulative properties. The laminations 203 may be comprised of a conducting material such as iron, various grades of steel, silicon steel, electrical steel, etc., although other materials may be used. The stator core support plate 202 may be comprised of steel, although other materials may be possible. The stator core support plate 202 and laminations 203 may be comprised of conductive materials such as steel and may be at ground potential (i.e., both may possess zero voltage).

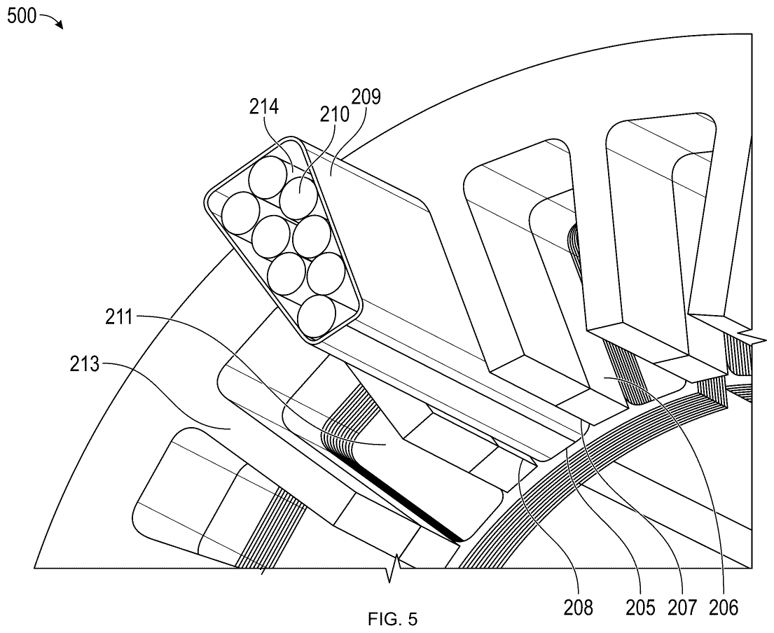

FIG. 5 is an illustration 500 depicting a magnified view of an end turn assembly and one illustrative conductor bundle. The illustration 500 includes the stator core edge 205, the stator core support plate edge 206, areas of vulnerability 207-208, a bundle electrical insulation 209 surrounding a conductor bundle 210, a slot 211, an electrical insulation tooth 213, and one or more insulated conductors 214. The conductor bundle 210, as shown with eight insulated conductors 214, and bundle electrical insulation 209 may be similar to each of the windings 204 of FIG. 2. The conductor bundle 210 may include the one or more insulated conductors 214 which may each be configured to carry alternating current (AC) voltage at a fundamental frequency and various other frequencies. While not shown in FIG. 5, each slot 211 may include a conductor bundle 210 and bundle electrical insulation 209 between a pair of electrically insulating teeth 213.

The electric field generated via voltages impinged on the conductor bundle 210 may be stronger at the entrance/exit of the stator core as the conductors transition to/from air and the insulating medium inside the stator core. PD events may occur more frequently at the areas of vulnerability 207-208 near the tip of each electrical insulation tooth 213. The tip of each electrical insulation tooth 213 may refer to the innermost radial extent of each electrical insulation tooth. The areas of vulnerability 207-208 may refer to weak points in the bundle electrical insulation 209 and the electrical insulation of the insulated conductors 214 which may be potentially exposed to PD events. A large number of ESP motor failures may occur because of PD resultant electrical insulation failures at the gap between the end turn support structure 201 and the stator core laminations beyond the stator core edge 205. The areas of vulnerability 207-208 may be located within this gap.

Weaknesses may form over time at the areas of vulnerability 207-208, and some of the weaknesses in the bundle electrical insulation 209 and the electrical insulation of the insulated conductors 214 may occur during the manufacturing process, wrapping of the conductors, etc. For example, air bubbles, airgaps, and other imperfections may appear between different layers and around the edges of the bundle electrical insulation 209 and/or the electrical insulation of the insulated conductors 214. The electrical insulation may be comprised of an insulating tape that is wrapped around each individual conductor of the insulated conductors 214. Imperfections such as airgaps may also arise between the tape and the conductors. PD events may be present when large electric fields are generated in these imperfections within the electrical insulation due to large voltage differentials and abrupt changes in the geometry of the windings.

As the voltage through the conductor bundle 210 exceeds a threshold, such as a partial discharge inception voltage threshold, PD events may occur. For example, if the electric field exceeds the breakdown electric field of air, partial discharge (PD) events may occur at these imperfections. Molecules of oxygen, nitrogen, etc. within the air gaps may ionize, accelerate, and gather kinetic energy under the effect of the magnetic field and thus impact the electrical insulation layer. Over time, the ionized gases may alter the structure of the insulating material. Carbonization, acid formation, and other forms of erosion may degrade the electrical insulation layers over the conductors 214 and the bundle electrical insulation 209 through repeated impact, chemical and/or arcing processes, etc. In particular, PD events and the eventual PD resultant failure of the bundle electrical insulation 209 (and of the electrical insulation of each of the insulated conductors 214) may occur at the areas where the conductors enter the stator core.

With reference to FIG. 5, each slot 211 may be flanked by the electrical insulating teeth 213. Traditional ESP motors and end turn support structures, as depicted in FIGS. 2-5, may utilize open-slot end turn support structures. The PEEK electrical insulation of the end turn support structure 201 may be in direct contact with the stator core of the motor. For example, the end turn support structure 201 may be in contact with the stator core at the stator core edge 205. An electric field may be present at nearly all locations proximate to the stator core, but the maximum electric field may be located at the stator core edge 205, where the conductor bundle 210 transitions from the ground electrical insulation of the laminations 203 and the stator core support plate 202 directly into the stator core of the motor 116. Generally, the electric field may peak at locations close to the ground where the maximum gradient of voltage occurs, and PD events may occur at these locations.

### Example Modified End Turn Support Structures

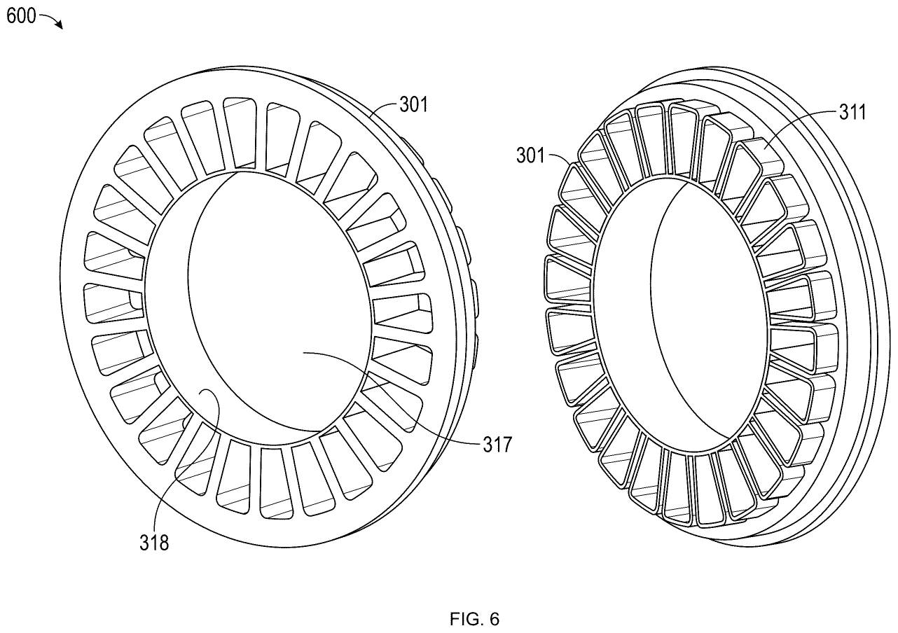

A modified end turn support structure and other electrical insulation modifications are now described. FIG. 6 is an illustration 600 depicting a modified end turn support structure, according to some implementations. An end turn support structure 301 may be a member including a plurality of closed, deepened slots 311. As shown, the slots are spaced at 15° angular increments around the perimeter of the end turn support structure 301, though in other implementations the slots may be spaced at greater increments or smaller increments. For example, some implementations may utilize slots that are spaced at 10° angular increments around the perimeter of the end turn support 301 to accommodate additional windings. Each of the slots 311 may be of the same size, but in other implementations, different-size slots may be used. Some implementations may use uniformly-sized slots, although other implementations of the end turn support structure 301 may include a combination of slot sizes. For example, at least a portion of the slots 311 may be comprised of a first size, and at least a portion of the slots 311 may be comprised of a second size. The slot size may refer to the length of each of the slots 311, the width of each of the slots 311, the depth of each of the slots 311, etc.

As shown, the end turn support structure 301 may be a shallow cylinder and/or washer-shaped member with a hollow bore 317 through its center. However, other geometries may be possible. The bore 317 may be sized such that a rotor of the ESP may be configured to pass through the bore 317. Accordingly, a barrier 318 may be included around the perimeter of the bore 317. The barrier 318 may form at least a portion of the border of the closed, deepened slots 311 and may be positioned between the bore 317 and the closed, deepened slots 311. Therefore, the barrier 318 may close the closed, deepened slots 311 and isolate them from the bore 317. The end turn support structure 301 may be a monolithic component, and the barrier 318 may be a structural feature of the end turn support structure 301. Other configurations may also be possible.

Each of the closed, deepened slots 311 may be configured to pass through the body of the end turn support structure 301. The closed, deepened slots 311 may be formed in the end turn support structure 301 around the perimeter of the bore 317. The closed, deepened slots 311 may include through-holes which pass one or more conductor bundles through the end turn support structure 301. However, other configurations may be possible.

While an example configuration is depicted in FIG. 6, various quantities of the slots 311, shape of the slots 311, and size of each of the slots 311 may be possible. In some implementations, each of the closed, deepened slots 311 may be positioned equidistant from the center of the bore 317 within the body of the end turn support structure 301. The closed, deepened slots 311 may include slot extensions which may have depths of different ranges (such as 2 mm to 12 mm), depending on the diameter of the stator. However, other configurations and slot depths may be possible.

The end turn support structure 301 may completely surround all edges of each of the slots. In contrast to the open electrical insulating teeth 213, the closed, deepened slots 311 may provide additional electrical insulation for conductor bundles passing through the slots 311. The closed, deepened slots 311 may include slot extensions that form deep pockets extending from each slot 311 that nest within at least a portion of the slots of the stator core support plate 202. Nesting may refer to a fit such that at least a portion of the slots 311 of the end turn support structure 301 may mechanically couple with at least a portion of the slots of the stator core support plate 202. In some implementations, the mechanical coupling may include an interference fit, a friction fit, etc., although other means of nesting the slots 311 within the stator core support plate 202 may be possible. Therefore, the closed, deepened slots 311, having the slots extensions, may couple the end turn support structure 301 with the stator core support plate 202. The closed, deepened slots 311 may eliminate direct contact between electrical insulation layers such as the bundle electrical insulation 209, the electrical insulation over the insulated conductors 214, etc. and electric conducting bodies such as the stator core support plate 202.

In addition to this change in geometry via the slots 311, the materials of the end turn support structure 301 may also be optimized for PD event mitigation. In some implementations, the end turn support structure 301 may be comprised of materials such that the end turn support structure 301 exhibits one or more semiconductive characteristics. For example, the end turn support structure 301 may be comprised of and/or include a thermoplastic insulator, such as PEEK, with the inclusion of a doped material. A doped material may refer to a first material which has been doped by a smaller amount of a second material such that one or more of material properties of the first material (e.g., conductivity, resistivity, modulus of elasticity, coefficient of thermal expansion, etc.) are changed. The second material may be referred to as the dopant. Some implementations of the doped material may also be referred to as an extrinsic semiconductor.

In some implementations, the doped material may include a doped microvaristor, such as Zinc Oxide (ZnO) doped with one or more dopants. However, other materials (which may be doped), such as one or more electroceramics, silicon carbide (SiC), materials with non-linear conduction characteristics, etc. may also be included with the end turn support structure 301. The concentration of the doped material within the resulting composite may affect the non-linear conduction characteristics. Other potential varistors to be included with the end turn support structure 301 may include Cobalt (III) Oxide (Co₂O₃), Bismuth Oxide (Bi₂O₃), Manganese Dioxide (MnO₂), Nickel Oxide (NiO), Antimony Oxide (Sb₂O₃), other metal oxides, etc. These microvaristors may also be doped by one or more dopants to alter their material properties.

The doped microvaristor (such as doped ZnO) may be a filler material in the form of one or more grains, powders, spheres, polycrystalline fillers, etc. that is mixed with the thermoplastic insulator (e.g., PEEK) during manufacturing. In some implementations, the doped microvaristor (such as doped ZnO) may be included with the end turn support structure 301 as a coating. At low electric fields, the doped microvaristor may exhibit a linear current-voltage relationship. Above a threshold electric field strength, the conductivity of the doped microvaristor (and resulting composite) may start to increase, characterized by a nonlinear increase in the current around areas of high voltage.

Filler materials, such as ZnO microvaristors (and/or other varistors), may be doped with various materials to further enhance and/or tailor their properties for performance and durability. For example, Bismuth (Bi), Cobalt (Co), Manganese (Mn), Antimony (Sb), Nickel (Ni), Chromium (Cr), Aluminum (Al) and Gallium (Ga) may be used as the dopants for doping the ZnO microvaristors. However, other dopants may be used. The inclusion of a doped microvaristor may cause the resulting composite end turn support structure to exhibit one or more semiconductive characteristics which may enable homogenizing the electric field in the end turn region, may clamp voltage spikes, and may suppress PD events. The variation of the electric field in the end turn region may decrease as the filler material concentration increases, as the non-linear conductivity of the end turn support structure 301 may be determined by the conduction paths formed by the filler material (e.g., the doped microvaristors). Example semiconductive characteristics exhibited by the end turn support structure 301 (after inclusion of the doped material) may include improved dielectric properties such as a higher dielectric constant (relative permittivity) ranging from 4 to 50, a dielectric loss (dissipation factor) ranging from 0.01 to 0.1 at frequencies of 1 kilohertz (kHz) to 1 megahertz (MHz), a breakdown strength ranging from 100 to 300 kilovolts per millimeter (kV/mm), a volume resistivity ranging from 10¹⁰ to 10¹⁴ ohm-centimeters (ohm-cm), a variable electrical conductivity between 10⁻¹⁴ to 10⁻⁸ Siemens per centimeter (S/cm), a controlled surface resistivity, a high thermal conductivity ranging from 0.2 to 1.5 Watts/meters-Kelvin (W/m·K), a high impedance (e.g., greater than 300 ohms, although other values may be possible), a partial discharge inception voltage (PDIV) ranging from 1 to 5 kV (dependent on material thickness, configuration, etc.) etc. Other properties and values may also be possible. The inclusion of the doped material may lower the volume resistivity of the end turn support structure 301 from approximately 10¹⁵ to 10¹⁶ ohm-cm (without the doped material) to the above range of 10¹⁰ to 10¹⁴ ohm-cm. This may allow a freer movement of electric charges which may diffuse the electric field in the end turn region. The end turn support structure 301, with the doped material, may be configured to lower the concentration of the electric field in the end turn region while still retaining a high electrical insulation resistance.

The end turn support structure 301, with the inclusion of the doped microvaristor, may contribute to a reduced occurrence or suppression of PD events in the end turn area. In some implementations, the end turn support structure 301 may be doped with the microvaristors and/or similar material before, during, or after the molding process of the end turn support structure 301. In some implementations, the end turn support structure 301 may be created via injection molding and machining, created via additive manufacturing, etc. Other manufacturing techniques may also be used.

The end turn support structure 301, as modified, may allow for a smoother transition between the electric field observed outside the stator core and the electric field within the stator core. The microvaristors may contribute to homogenizing the electric field in the region of the end turn support structure 301 and reducing its magnitude. By reducing the gradient of the electric field, the electric field in the end turn location may be decreased to levels that the various electrical insulation systems in the area may withstand, reducing the prevalence of PD events.

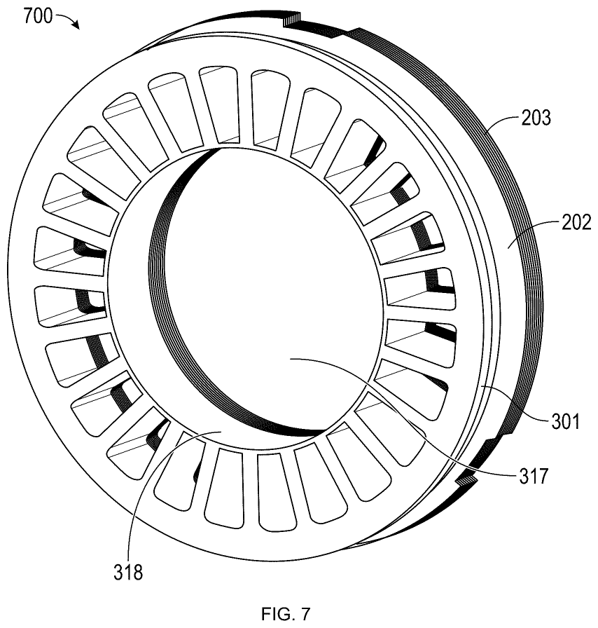

FIG. 7 is an illustration 700 depicting a modified end turn support partial assembly including stator laminations 203 and a support plate 202, according to some implementations. The illustration 700 includes the end turn support structure 301 which may be comprised of a thermoplastic insulator supplemented with a doped material. In some implementations, the end turn support structure 301 may be comprised of a PEEK-microvaristor composite and may include modified slots such as the closed, deepened slots 311. The illustration 700 further includes laminations 203, the stator core support plate 202, the bore 317, and the barrier 318. At least a portion of the stator core support plate 202 may be inserted in the end turn support structure 301. In some implementations, at least a portion of the end turn support structure 301 may be inserted in the stator core support plate 202. The stator core support plate 202 may be attached to the laminations 203 of the stator core.

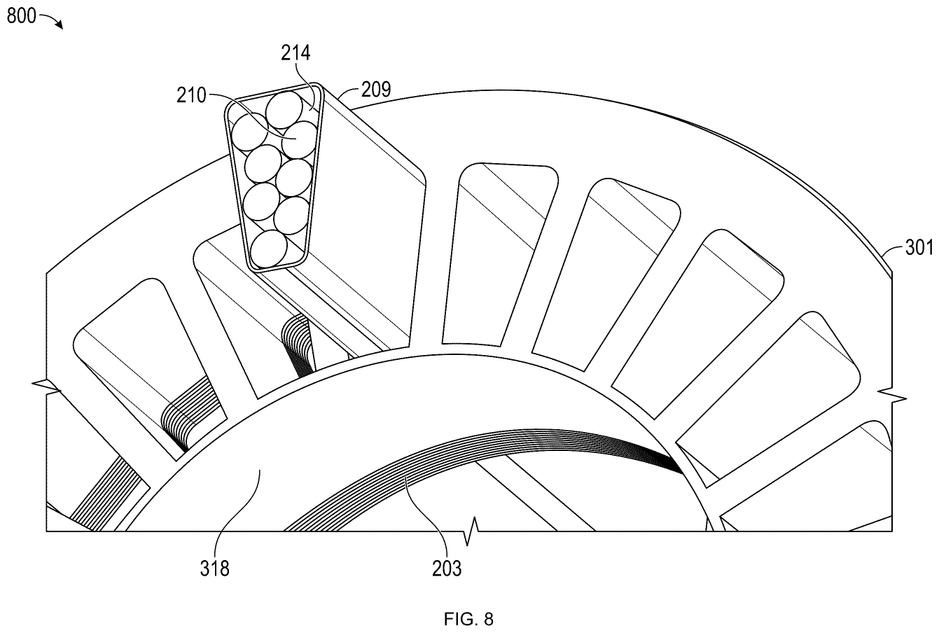

FIG. 8 is an illustration 800 depicting an end turn including a slot liner and one conductor bundle, according to some implementations. The illustration 800 includes the end turn support structure 301, laminations 203, a conductor bundle 210 and its insulated conductors 214, the barrier 318, and bundle electrical insulation 209. The bundle electrical insulation 209 may be a slot liner or any other electrical insulation layer. Other configurations may also be possible.

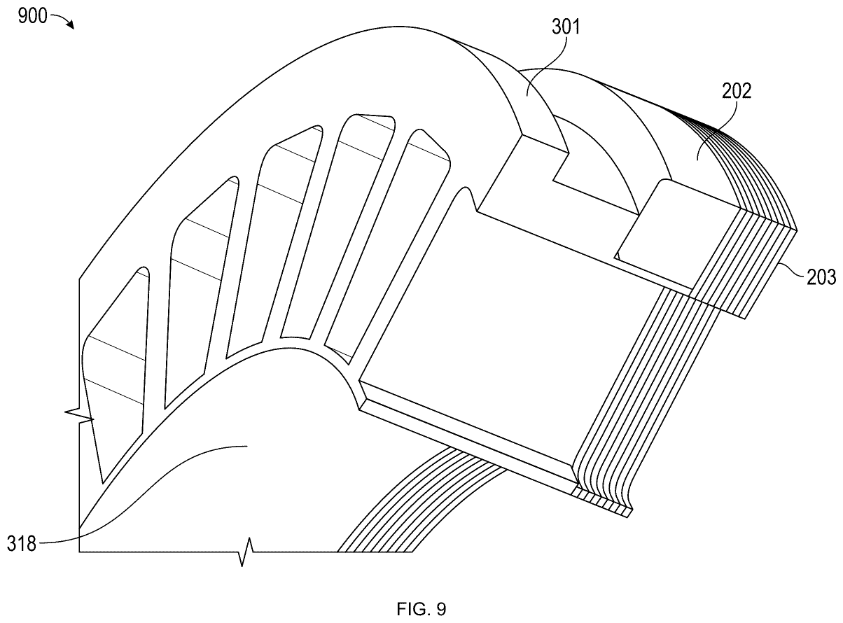

FIG. 9 is a cross-sectional diagram 900 depicting a modified end turn support structure including stator laminations and the support plate, according to some implementations. The diagram 900 includes the end turn support structure 301, the stator core support plate 202, the barrier 318, and the laminations 203. As shown, the slots and pockets (also referred to as slot extensions) in the end turn support structure 301 may be deepened to allow the stator core support plate 202 to be surrounded by a semiconductive compound, by a material which exhibits one or more semiconductive characteristics, etc. Also depicted in the diagram 900, at least a portion of the stator core support plate 202 and at least a portion of the end turn support structure 301 may be configured to couple and may nest within one other. At least a portion of the end turn support structure 301 may be positioned underneath the stator core support plate 202 to provide additional electrical insulation. Therefore, the end turn support structure 301, having the closed, deepened slots, may extend additional electrical insulation for the conductor bundle 210 and bundle electrical insulation 209 up to the laminations 203.

In some implementations, the stator core support plate 202 may push against the laminations 203 to form the compressed assembly. The stator core support plate 202 may be a thicker lamination used to compress the lamination stack formed by the laminations 203. In some implementations, the stator core support plate 202 may be welded to the stator core and motor casing (not shown) for stability. The stator core support plate 202 may be supported by a snap ring to hold the laminations 203 in compression, although other supporting structures may be used.

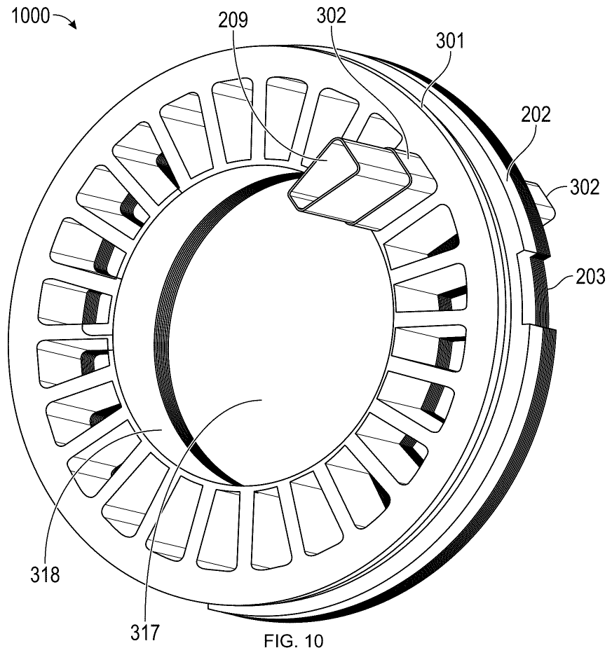

FIG. 10 is an illustration 1000 depicting the modified end turn support structure and a protective film, according to some implementations. The illustration 1000 includes the end turn support structure 301, laminations 203, the bundle electrical insulation 209 (also referred to as a slot liner), the stator core support plate 202, the bore 317, the barrier 318, and a composite film 302. At least a portion of the composite film 302 may be comprised of polyimide, although other materials may also be used. For example, the composite film 302 may be comprised of a semiconductor or a material that exhibits one or more semiconductive characteristics (e.g., non-linear electrical conductivity). The composite film 302 may protrude from both ends of each slot of the end turn support structure 301. For example, the composite film 302 may be configured to extend past the laminations 203 partially into the stator core and extend past the end turn support structure 301 on the opposing end, as shown. The composite film 302 may be a multi-layer film having more than one layer. In some implementations, the composite film 302 may be a dual-layer film consisting of one conductive layer and one insulating layer to provide further protection against PD events in the end turn region of the stator. Other configurations for the composite film 302, such as a single layer film, a tri-layer film, a film with four or more layers, etc. may also be possible. Any number of layers may be used within the composite film 302. Accordingly, implementations with wider slots may permit a composite film 302 with a greater total thickness. In some implementations, a layer of the composite film 302 may be defined as a laterally contiguous material. Additional layers may be stratified (i.e., positioned above and below one another), but individual layers may not splice into or pass through one another. However, individual layers may include differing embedded materials within their boundaries. For example, a dual-layer composite film 302 may be comprised of a polyimide tape. The tape may include two layers: an insulative layer comprised of polyimide and a conductive layer comprised of an adhesive with conductive elements embedded therein. Embedded conductive elements may include embedded copper spheres, embedded nickel-plated particles, etc. Other conductive elements may also be used. In some implementations, the composite film 302 may be a single-layer insulative layer with conductive elements embedded within the single insulative layer. Other scenarios for the composite film 302 may also be possible.

The composite film 302 may be a laminate material. In configurations having two or more layers, the composite film 302 may include interleaved conductive and insulative layers which may provide a high impedance and/or resistance media. The conductive layer(s) may be comprised of copper, aluminum, copper alloy, aluminum alloy, etc. The insulative layer(s) may preferably be comprised of polyimide. However, other materials such as fiberglass-reinforced epoxy resin (FR4) and other insulating materials may also be used. In some implementations, the conductive and insulative layers may be comprised of films, foils, tapes, etc. In some implementations, a tri-layer composite film may include a conductive layer laminated on both sides of an insulative substrate. Accordingly, a tri-layer composite film may include an insulative layer laminated on both sides of a conductive substrate. Various interleaving configurations of the layers may be possible.

In addition to the microvaristors of the end turn support structure 301, the composite film 302 may diffuse the electric field generated in the end turn region and prevent current discharge. Each slot of the end turn support structure 301 may include a respective composite film 302. In some implementations, the bundle electrical insulation 209 may also be comprised of polyimide.

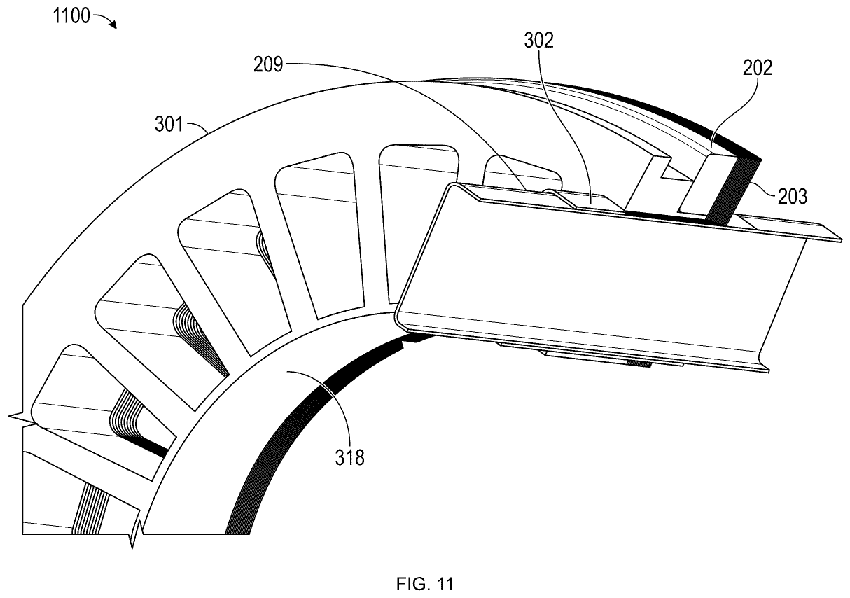

FIG. 11 is a cross-sectional diagram 1100 depicting the modified end turn support structure and the protective film, according to some implementations. The cross-sectional diagram 1100 includes the end turn support structure 301 (having the closed, deepened slots), the bundle electrical insulation 209, the composite film 302, the stator core support plate 202, the barrier 318, and the laminations 203. As described, the composite film 302 may be a dual-layer insulating conductor. The composite film 302 may be a high-temperature resistant polyimide film with an operating range up to 260° C. (500° F.) configured for placement in deep wells with bottom hole temperatures greater than 150° C. (or approximately 300° F.), geothermal wells, etc. The insulating portion of the composite film 302 may provide additional electrical insulation at the end turn region where electrical insulation stresses are observed. A conducting portion of the composite film 302 may possess a surface resistance in the range of 10² and 10⁸ ohms per square (Ω/sq) and may cause the composite film 302 to be partially conductive. This range may provide the appropriate balance between field grading, charge dissipation and minimizing conduction losses. The surface resistance in this range may also aid in homogenizing the electric field and reducing the area with the peak field that may initiate PD events. It may also allow a controlled dissipation of electric surface charges, preventing the buildup of localized large electric fields.

Because both the end turn support structure 301 and composite film 302 may be in contact with the stator core at various locations, such as in the end turn region and within the slots of the stator core, the end turn support structure 301 and composite film 302 may operate at ground potential because of their contact with the stator core. Thus, the voltage across any air gaps or imperfections may equal zero. PD events may not occur in these air gaps, because the electric stresses there may not exceed 3 kV/mm. Therefore, partially conductive mediums such as the end turn support structure 301, and partially conductive mediums with a surface resistance ranging from 100 to 108 Ω/sq, may prevent surface discharges (i.e., PD events) from occurring.

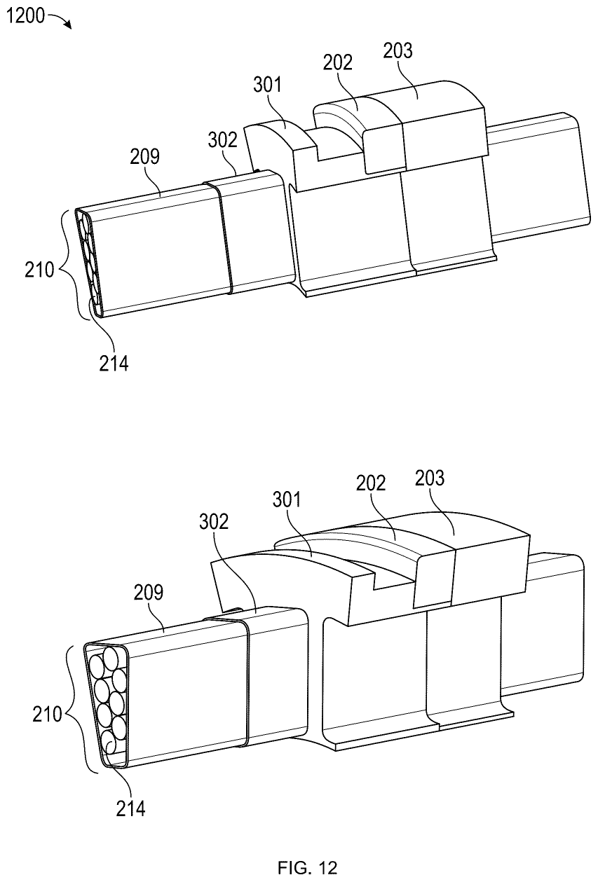

FIG. 12 is an illustration 1200 depicting side views of the modified end turn support structure including the protective film, according to some implementations. The illustration 1200 includes the conductor bundle 210 having the insulated conductors 214, the bundle electrical insulation 209, the end turn support structure 301, the stator core support plate 202, the laminations 203, and the composite film 302. As shown, the composite film 302 may extend beyond the end turn support structure 301. Similar to FIG. 6, the end turn support structure 301 may include deepened and closed slots to provide additional electrical insulation. At least a portion of the end turn support structure 301 may separate the stator core support plate 202 (a ground) from the bundle electrical insulation 209 and conductor bundle 210. As shown, at least a portion of the end turn support structure 301 may nest underneath a portion of the stator core support plate 202.

As discussed in FIG. 5, contact between the bundle electrical insulation 209 and a ground may occur at the stator core edge 205 in traditional systems. With the inclusion of the composite film 302 and the closed, deepened slots of the end turn support structure 301, direct contact between insulating layers (such as the bundle electrical insulation 209) and a ground, such as the laminations 203, may be eliminated. The additional electrical insulation and the introduction of semiconductive characteristics via the composite film 302 and end turn support structure 301 may smoothen the electric field gradient between conductors/grounds and each conductor bundle. As such, there may be a semiconductive material or compound between the insulated conductors 214, each conductor bundle 210, etc. and metal parts of the stator that are grounded.

### Example Method of Operations

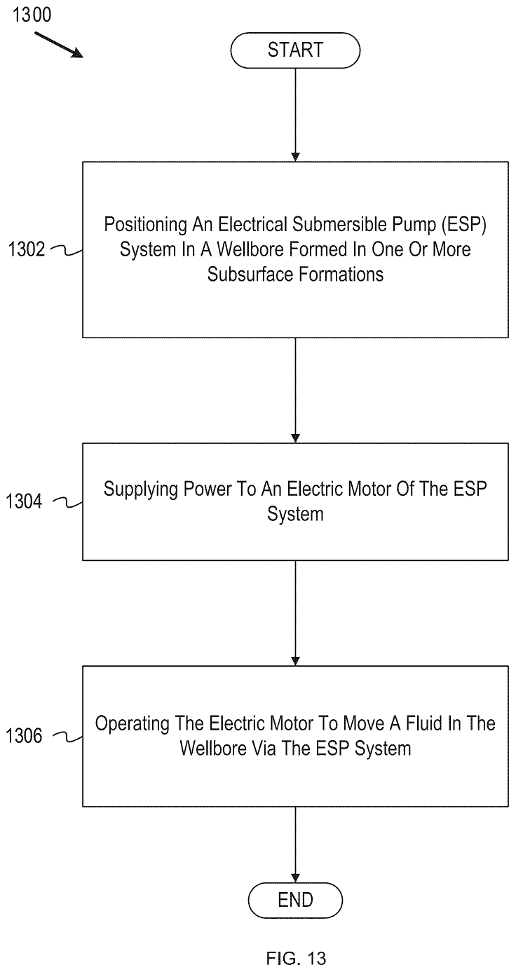

FIG. 13 is a flowchart depicting an example method of operations, according to some implementations. Operations of a method 1300 may be performed by software, firmware, hardware, or a combination thereof. Such operations are described with reference to FIGS. 1 and 6-12. However, such operations may be performed by other systems or components. The operations of the method 1300 begin at block 1302.

At block 1302, the method 1300 includes positioning an electrical submersible pump (ESP) system in a wellbore formed in one or more subsurface formations. For example, the tubing 122 may be used to convey the ESP system 150 to a target depth in the wellbore 104. Flow progresses to block 1304.

At block 1304, the method 1300 includes supplying power to an electric motor of the ESP system. The electric motor may include a motor rotor, a stator core, and a bore (such as the bore 317) through which the motor rotor is capable of being located. A member, such as the end turn support structure 301, may include one or more of the closed, deepened slots 311. The end turn support structure 301 may be configured to couple to an end of the stator core of the motor. The end turn support structure 301 may be formed from a material (such as PEEK, PE, PVC, other thermoplastic insulators, etc.) with the inclusion of a doped material such as a doped microvaristor (e.g., a ZnO microvaristor). The closed, deepened slots 311 and the inclusion of the doped microvaristor may limit both the incidence rate and damage done by PD events.

In some implementations, the end turn support structure 301, with the inclusion of the doped material, may exhibit one or more semiconductive characteristics including a high dielectric constant (relative permittivity) ranging from 4 to 50, a dielectric loss (dissipation factor) ranging from 0.01 to 0.1 at frequencies of 1 kilohertz (kHz) to 1 megahertz (MHz), a breakdown strength ranging from 100 to 300 kilovolts per millimeter (kV/mm), a lowered volume resistivity ranging from 10¹⁰ to 10¹⁴ ohm-cm, a variable electrical conductivity between 10⁻¹⁴ to 10⁻⁸ Siemens per centimeter (S/cm), a controlled surface resistivity, a high thermal conductivity ranging from 0.2 to 1.5 Watts/meters-Kelvin (W/m·K), a high impedance (e.g., greater than 300 ohms, although other values may be possible), a partial discharge inception voltage (PDIV) ranging from 1 to 5 kV (dependent on material thickness, configuration, etc.), etc. These characteristics may result in a homogenizing of the electric field in the end turn region, clamping voltage spikes, suppressing PD events, etc. Other properties and values may also be possible.

A laminate material may be configured to be positioned within at least one of the one or more slots (slots 311) of the end turn support structure 301. This laminate material may include at least one of a conductive layer or an insulative layer. One or more of the closed, deepened slots 311 may be formed in the end turn support structure 301 around a perimeter of the bore 317. In some implementations, perimeter of the bore 317 may be defined by the barrier 318. The closed, deepened slots 311 may insulate one or more conductors configured to pass through the at least one slot via the end turn support structure 301. In some implementations, each slot of the closed, deepened slots 311 may include a respective laminate material such as the composite film 302. In other implementations, laminate material may be configured to be positioned in some of the slots 311. The composite film 302 may include one or more layers including at least one conductive layer and/or at least one insulative layer to reduce the electric field concentration in the end turn region where conductor bundles exit the stator core. In some implementations, the composite film 302 may be comprised of or may include an insulative layer comprised of polyimide. The composite film 302 may inhibit PD events by insulating each conductor bundle 210 from grounds such as the stator core support plate 202 and laminations 203. Flow progresses to block 1306.

At block 1306, the method 1300 includes operating the electric motor to move a fluid in the wellbore via the ESP system. For example, the ESP system 150 may be configured to move the fluid 126 in the wellbore 104. In particular, the motor 116 may be configured to drive the pump 108 of the ESP system 150 which may move the fluid in the wellbore 104. Flow of the method 1300 ceases.

### Example Geothermal Well System

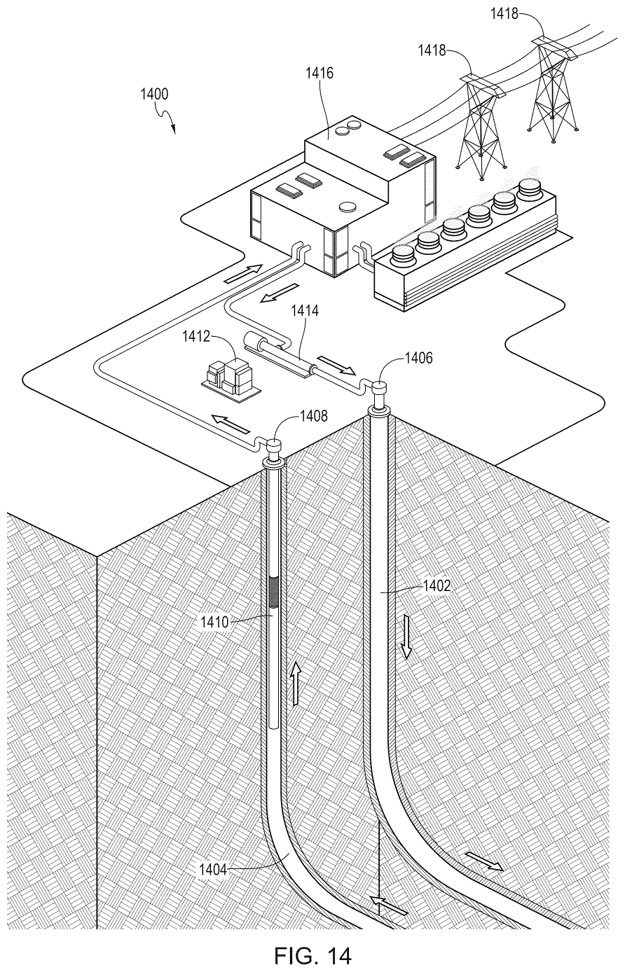

FIG. 14 is an illustration 1400 depicting an example ESP configured for use in a geothermal well, according to some implementations. The illustration 1400 includes an injection conduit 1402, a production conduit 1404, an injection wellhead 1406, a production wellhead 1408, an electrical submersible pump (ESP) 1410, a variable speed drive 1412, a pumping system 1414, a power facility 1416, and power infrastructure 1418. In some implementations, the injection conduit 1402 and production conduit 1404 may be included within a single wellbore, the injection conduit 1402 and production conduit 1404 may comprise separate wellbores, etc. The ESP 1410 may be similar to the ESP system 150 of FIG. 1. In some implementations, the variable speed drive 1412 may be similar to the VSD 119 of FIG. 1.

The ESP 1410 may be used in various geothermal environments and operations as part of a geothermal production system. For example, the ESP 1410 may be used in an injection-production system where fluid is injected downhole using an injector well (the injection conduit 1402) and produced to the surface via a production well (the production conduit 1404). In some implementations, the ESP 1410 may be used in closed-loop geothermal operations and installed in a closed-loop geothermal well. However, other well configurations may be possible. The ESP 1410 may be used in shallow geothermal wells less than three kilometers in depth and in deep geothermal wells greater than three kilometers in depth. The ESP 1410 may be configured to pump various heat transfer fluids including water, carbon dioxide (CO₂), one or more hydrocarbons, one or more refrigerants, and other fluids as a single-phase liquid, two-phase fluid flow, etc. A heat transfer fluid may refer to a fluid with a The ESP 1410 may be configured to pump a fluid with a lifting head greater than 2,000 meters (greater than approximately 6,550 ft). The ESP 1410 may be installed at a depth in a wellbore having an ambient temperature of at least 150° C. (approximately 302° F.). However, the ESP 1410 may also be installed at a depth in a wellbore having an ambient temperature less than 150° C. Example operating temperatures of the ESP 1410 may include 175° C., 200° C., 225° C., 250° C., etc.

Similarly, the ESP 1410 may be configured to pump fluid having a temperature greater than or equal to 150° C. However, the ESP 1410 may also be configured to pump fluids having temperatures less than 150° C. Example fluid temperatures which may be pumped by the ESP 1410 may include 175° C., 200° C., 225° C., 250° C., etc. An injected fluid or an in-situ fluid downhole may receive thermal energy from a geothermal reservoir, and this thermal energy may be produced to the surface via the production conduit 1404 using the ESP 1410. In some implementations, the fluid containing the thermal energy may be pumped through the production conduit 1404 via the ESP 1410. The thermal energy from the produced fluid(s) may be used for power generation at the power facility 1416 and transmission via the power infrastructure 1418. Alternatively, the fluid pumped from the production conduit 1404 and ESP 1410 may be used for heating. While the ESP 1410 is depicted as installed within the production conduit 1404, the ESP 1410 may be positioned at any depth within the production conduit 1404 or injection conduit 1402. The ESP 1410 may be configured to move a heat transfer fluid out of the production conduit 1404 to the surface, configured to move a heat transfer fluid from

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed. Similarly, “at least one of: a, b, or c” is intended to cover: a, b, c, a-b, a-c, b-c, and a-b-c.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well may be horizontal or even slightly directed upwards. Unless otherwise specified, use of the terms “subsurface formation” or “subterranean formation” shall be construed as encompassing both areas below exposed earth and areas below earth covered by water such as ocean or fresh water.

### Example Implementations

Implementation #1: An apparatus comprising: a member configured to couple to an end of a stator core of an electrical submersible pump (ESP) motor, the ESP motor to be positioned in a wellbore, wherein the member has a bore through which a motor rotor is to be located, wherein one or more slots are formed in the member around a perimeter of the bore, wherein the member includes a doped material, and wherein the member including the doped material exhibits one or more semiconductive characteristics, and wherein a laminate material is configured to be positioned within at least one of the one or more slots, and wherein the laminate material includes at least one of a conductive layer or an insulative layer.

Implementation #2: The apparatus of Implementation 1, wherein the member comprises a thermoplastic insulator.

Implementation #3: The apparatus of any one or more of Implementations 1-2, wherein the doped material comprises a doped microvaristor.

Implementation #4: The apparatus of any one or more of Implementations 1-3, wherein each slot comprises two ends, wherein the laminate material is configured to be positioned within each of the one or more slots, further wherein the laminate material protrudes from both ends of each of the one or more slots, and wherein at least a portion of the laminate material is configured to extend past a lamination stack of the stator core.

Implementation #5: The apparatus of any one or more of Implementations 1-4, wherein the member is an end turn support structure configured to couple with at least one of a stator core support plate and the lamination stack of the stator core.

Implementation #6: The apparatus of any one or more of Implementations 1-5, wherein one or more conductor wires are configured to be positioned in the one or more slots.

Implementation #7: The apparatus of any one or more of Implementations 1-6, wherein the member comprises a barrier positioned between the one or more slots and the bore, wherein the barrier isolates the one or more slots from the bore.

Implementation #8: The apparatus of any one or more of Implementations 1-7, wherein the member includes an extension for each of the one or more slots, and wherein the extension is configured to nest within a stator core support plate of the ESP motor.

Implementation #9: A system comprising: an electrical submersible pump (ESP) motor for use in a wellbore, the ESP motor comprising, a rotor; a stator core; and a member configured to couple to an end of the stator core and having a bore through which the rotor is to be located, wherein one or more slots are formed in the member around a perimeter of the bore, wherein the member includes a doped material, and wherein the member including the doped material exhibits one or more semiconductive characteristics, and wherein a laminate material is configured to be positioned within at least one of the one or more slots, and wherein the laminate material includes at least one of a conductive layer or an insulative layer.

Implementation #10: The system of Implementation 9, further comprising: a stator core support plate coupled to the member; and a lamination stack coupled to the stator core support plate and the stator core.

Implementation #11: The system of any one or more of Implementations 9-10, wherein each slot of the one or more slots comprises two ends, wherein the laminate material is configured to be positioned within each of the one or more slots, further, wherein the laminate material protrudes from both ends of each of the one or more slots, and wherein at least a portion of the laminate material is configured to extend past the lamination stack.

Implementation #12: The system of any one or more of Implementations 9-11, wherein the member includes an extension for each of the one or more slots, and wherein the extension is configured to nest within the stator core support plate.

Implementation #13: The system of any one or more of Implementations 9-12, wherein the member comprises a thermoplastic insulator.

Implementation #14: The system of any one or more of Implementations 9-13, wherein the doped material comprises a doped microvaristor.

Implementation #15: The system of any one or more of Implementations 9-14, wherein the member comprises a barrier positioned between the one or more slots and the bore, wherein the barrier isolates the one or more slots from the bore, and wherein one or more conductor wires are configured to be positioned in the one or more slots.

Implementation #16: A method comprising: positioning an electrical submersible pump (ESP) system in a wellbore, wherein the ESP system comprises an electric motor comprising a motor rotor and a stator core, wherein the electric motor includes a bore through which the motor rotor is capable of being located, wherein a member having one or more slots is configured to couple to an end of the stator core, wherein a doped material is included with the member such that the member exhibits one or more semiconductive characteristics, wherein a laminate material is configured to be positioned within at least one of the one or more slots, and wherein the laminate material includes at least one of a conductive layer or an insulative layer; and operating the electric motor to move a fluid in the wellbore via the ESP system.

Implementation #17: The method of Implementation 16, wherein the one or more slots are formed in the member around a perimeter of the bore, wherein a barrier is configured to isolate the one or more slots from the bore, and wherein one or more conductor wires are configured to be positioned in the one or more slots.

Implementation #18: The method of any one or more of Implementations 16-17, wherein the laminate material is configured to be positioned within each of the one or more slots, wherein at least a portion of the laminate material positioned within each of the one or more slots is configured to extend past a lamination stack of the electric motor, and wherein, the one or more conductor wires are insulated, via the laminate material, from at least one of a stator core support plate or the lamination stack of the electric motor.

Implementation #19: The method of any one or more of Implementations 16-18, wherein an extension is formed for each of the one or more slots, and wherein the member is coupled with the stator core support plate via the one or more slots having the extension.

Implementation #20: The method of any one or more of Implementations 16-19, wherein a doped microvaristor is included with the member such that the member exhibits the one or more semiconductive characteristics, wherein the doped material includes the doped microvaristor, and wherein the member is an end turn support structure.

Implementation #21: A method for manufacturing an electric motor of an electrical submersible pump (ESP), the method comprising: forming a member including a bore through which a rotor of the electric motor is to be located, wherein the member includes a filler material, and wherein the member including the filler material exhibits one or more semiconductive characteristics; forming one or more slots in the member around a perimeter of the bore; positioning a laminate material within at least one of the one or more slots, wherein the laminate material includes at least one of a conductive layer or an insulative layer; and coupling the member to an end of a stator core of the electric motor.

Implementation #22: The method of Implementation 21, wherein forming the member comprises forming an end turn support structure, wherein the end turn support structure is formed from a thermoplastic insulator, and wherein the filler material comprises a doped microvaristor.

Implementation #23: The method of any one or more of Implementations 21-22, further comprising: positioning one or more conductor wires in at least one of the one or more slots; and forming the member to include a barrier positioned between the one or more slots and the bore, wherein the barrier isolates the one or more slots from the bore.

Implementation #24: A method for producing thermal energy from the earth, the method comprising: positioning an electrical submersible pump (ESP) at a first depth in a first wellbore of a geothermal system; operating an electric motor of the ESP to drive the ESP, wherein the electric motor comprises a motor rotor and a stator core, wherein the electric motor includes a bore through which the motor rotor is capable of being located, wherein a member having one or more slots is configured to couple to an end of the stator core, wherein a doped material is included with the member such that the member exhibits one or more semiconductive characteristics, wherein a laminate material is configured to be positioned within at least one of the one or more slots, and wherein the laminate material includes at least one of a conductive layer or an insulative layer; and moving, via the ESP, a first fluid to a surface of the first wellbore.

Implementation #25: The method of Implementation 24, wherein the first depth of the first wellbore includes an ambient temperature greater than or equal to 150° C.

Implementation #26: The method of any one or more of Implementations 24-25, further comprising: injecting the first fluid via a second wellbore; and producing the first fluid via the first wellbore, wherein the first fluid comprises a temperature greater than or equal to 150° C.

Implementation #27: The method of any one or more of Implementations 24-26, wherein the member comprises a thermoplastic insulator, wherein a doped microvaristor is included with the member such that the member exhibits the one or more semiconductive characteristics, wherein the doped material includes the doped microvaristor, and wherein the member is an end turn support structure.

1. An apparatus comprising:
a member configured to couple to an end of a stator core of an electrical submersible pump (ESP) motor, the ESP motor to be positioned in a wellbore, wherein the member has a bore through which a motor rotor is to be located, wherein one or more slots are formed in the member around a perimeter of the bore, wherein the member includes a doped material, and wherein the member including the doped material exhibits one or more semiconductive characteristics, and
wherein a laminate material is configured to be positioned within at least one of the one or more slots, and wherein the laminate material includes at least one of a conductive layer or an insulative layer.

2. The apparatus of claim 1, wherein the member comprises a thermoplastic insulator.

3. The apparatus of claim 1, wherein the doped material comprises a doped microvaristor.

4. The apparatus of claim 1,
wherein each slot of the one or more slots comprises two ends,
wherein the laminate material is configured to be positioned within each of the one or more slots,
further, wherein the laminate material protrudes from both ends of each of the one or more slots, and
wherein at least a portion of the laminate material is configured to extend past a lamination stack of the stator core.

5. The apparatus of claim 4, wherein the member is an end turn support structure configured to couple with at least one of a stator core support plate and the lamination stack of the stator core.

6. The apparatus of claim 1, wherein one or more conductor wires are configured to be positioned in the one or more slots.

7. The apparatus of claim 1, wherein the member comprises a barrier positioned between the one or more slots and the bore, wherein the barrier isolates the one or more slots from the bore.

8. The apparatus of claim 1, wherein the member includes an extension for each of the one or more slots, and wherein the extension is configured to nest within a stator core support plate of the ESP motor.

9-27. (canceled)
